(19) United States
(12) Patent Application Publication
(10) Pub. No.: US 2010/0087214 A1
(43) Pub. Date: Apr. 8, 2010

(54) ASYNCHRONOUS URL NOTIFICATION

(75) Inventors: Isabelle Bournel, Cagnes-sur-Mer (FR); Gerard Marmigere, Drap (FR); Xavier Rey-Robert, La Gaude (FR); Vincent Tassy, Cagnes-sur-Mer (FR)

Correspondence Address: Cantor Colburn LLP-IBM Europe, 20 Church Street, 22nd Floor, Hartford, CT, 06103, US

(73) Assignee: International Business Machines Corporation, Armonk, NY (US)

(21) Appl. No.: 12/252,509

(22) Filed: Oct. 16, 2008

(30) Foreign Application Priority Data
Oct. 7, 2008 (FR) 08305645.7

(51) Int. Cl. H04W 4/20

(52) U.S. Cl. 455/466

(57) ABSTRACT

A method for sending a URL from a computing device to a recipient's mobile device, the method includes: generating a URL notification during an Internet session on a computing device; sending the URL notification to an Asynchronous URL Notification daemon; composing a Control SMS that comprises the URL; locating compatible communication devices; wherein the locating is performed with the daemon interacting with a local Bluetooth stack to identify the communication devices; wherein the communication devices are Bluetooth enabled devices that support an Asynchronous URL Notification profile; generating a list of communication devices; receiving the user's selection of a communication device; pairing the selected communication device with the computing device; retrieving an address book from the selected communication device; and displaying a list of recipients from the address book; sending the Control SMS to a recipient's mobile device in response to the user selection from the list of recipients.

This application claims priority to European Patent Application No. 08305645.7, filed 18 Jun. 2008, and all the benefits accruing therefrom under 35 U.S.C. §119, the contents of which in its entirety are herein incorporated by reference.

### BACKGROUND

This application claims priority to European Patent Application No. 08305645.7, filed 7 Oct. 2008, and all the benefits accruing therefrom under 35 U.S.C. §119, the contents of which in its entirety are herein incorporated by reference.

This invention relates generally to communication via wireless electronic devices, and more particularly to a method and system for sending information, such as an asynchronous URL notification, to a mobile device user who is not currently connected to the Internet.

Mobile communication devices, such as cellular phones, have become a central communication tool for both business and personal use. Competitive pressures and multiple billing options have lowered the subscriber cost of operation of mobile communication devices. In many instances, the mobile or cellular phone has replaced the traditional landline phone as a person's primary communication device. Advanced mobile communication devices offer not only voice services, but also text messaging and Internet access. Video and gaming applications are also now available on many mobile devices and service networks.

### SUMMARY

Embodiments of the present invention provide a method for sending a uniform resource locator (URL) notification from a computing device to a recipient's mobile communication device, the method includes: generating a URL notification emission during an Internet session on a computing device in response to a user command; sending the URL notification emission to an Asynchronous URL Notification daemon; composing a Control SMS (short message service) that comprises the URL notification emission; locating one or more compatible communication devices; wherein the locating is performed with the Asynchronous URL Notification daemon interacting with a local Bluetooth stack to identify the one or more compatible communication devices; wherein the one or more compatible communication devices are Bluetooth enabled devices in the vicinity of the computing device that support an Asynchronous URL Notification profile; generating a list of one or more compatible communication devices; receiving the user's selection of a compatible communication device from the list of one or more compatible communication devices; pairing the selected compatible communication device with the computing device; retrieving an address book from the selected compatible communication device; displaying a list of recipients from the address book; and sending the Control SMS to a recipient's mobile communication device in response to the user selection from the list of recipients.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow chart for sending a URL notification from a computing device to a recipient's mobile communication device according to embodiments of the invention.

FIG. 2 illustrates a flow chart for receiving a URL notification at a mobile device, and displaying the received URL on a recipient's computing device according to embodiments of the invention.

FIG. 3 illustrates a system for implementing embodiments of the invention.

The detailed description explains the preferred embodiments of the invention, together with advantages and features, by way of example with reference to the drawings.

### DETAILED DESCRIPTION

The widespread adoption of mobile communication devices has led to a significant increase in the use of mobile devices for the purpose of both business and personal communication. Along with the widespread adoption of mobile communication devices, the use of the Internet as an information and collaborative tool has increased as well. Internet users often wish to rapidly share a uniform resource locator (URL), which is an address or compact string of characters used to represent a resource or Web page available on the Internet, with another person who is currently not connected to the Internet.

Existing approaches for exchanging information, such as URLs, include instant messaging (IM) and electronic mail (email) that require both the sender and receiving users to be connected to the Internet, and to have software installed and configured on their respective computing devices. Information notifications based on new email polling may take a long period of time before a receiving user is notified. In addition, sending information, such as long URLs, via IM, email, or even short messaging system (SMS) is cumbersome to type in and error prone. Typing a received URL back into a receiver's web browser is also tedious and subject to error. Therefore, there is a need to facilitate the exchange of information, such as URLs, between Internet connected users and non-connected users.

Embodiments of the invention provide a method and system for transmitting notification information, such as an URL address, from a first user connected to the Internet to a second user connected to a mobile phone network, by identifying a Bluetooth paired mobile device in the vicinity of the first user, and transmitting the notification information to the second user through the mobile phone network using short message service (SMS), with the mobile device of the second user being configured to display the notification information when received.

Embodiments of the invention provide a means for sharing Web page locations (URLs) in mobile communication environments, where the receiver of the URL is currently not connected to the Internet. For example, a first user is browsing a Web page, and requires a second user to view the Web page as soon as possible. However, the second user is not currently on line. Embodiments of the invention notify the second user to view the Web page via their mobile device.

Embodiments of the invention transmit information, such as URLs, via wireless protocols, including Global System for Mobile communications (GSM), in response to an originating request by a user. Upon a user request, the user's Web browser conveys a URL via a wired or wireless communication means to a device (mobile or non-mobile) configured for SMS. Short message service is a communications protocol for the interchange short text messages between mobile devices. The received SMS with the URL, at the addressee's mobile device, may then be automatically transferred to an addressee's device that is configured to launch a Web browser with the received URL. By relying on wireless protocol links, instead of the Internet, receiving users are notified even when not connected to the Internet. In addition, with embodiments of the invention the automated emission and reception of information eliminates the need for manual typing and cut and paste activities that often lead to typographical errors.

In embodiments of the invention, a user's wireless communications device may establish a wireless communications link with the user's computer via a wireless protocol such as Bluetooth. Many types of portable communication devices such as cell phones (mobile phones), and personal digital assistants (PDA) are configured with Bluetooth, which is a short-range wireless link protocol. A user's wireless communications device may also be placed into a docking cradle that has a wired connection to the user's computer. Alternatively, a data cable, such as a universal serial bus (USB), may be utilized to establish a communication link between the user's communication device and their computer.

In embodiments of the invention, information, such as a URL, is transferred from a device connected to the Internet to a notification daemon. A daemon (Disk And Execution MONitor) is a computer program that runs in the background (often with out a graphical user interface (GUI)), rather than under the direct control of a user. The notification daemon identifies one or more wireless mobile devices, such as mobile devices configured with Bluetooth, in the vicinity of the user who wants to transfer the information to another remote mobile device. Subsequently, the user selects from a list, generated by the daemon, an available transmitting mobile device to send the information to another remote receiving mobile device. In the event the transmitting device is already a Bluetooth paired device with a computer that the user is using for Internet access, the daemon retrieves the address book from the device selected through a standard Phonebook Access Bluetooth profile, and composes an SMS with the information, and transmits the SMS to a remote user connected to a mobile phone network.

In embodiments of the invention, the daemon may offer the user a choice of remote devices to send the notification information, with the choices displayed as a pop up window generated by a graphical user interface (GUI). In the event user's Internet access computing device is not already paired with a selected Bluetooth device, a standard pairing procedure that is provided by the local Bluetooth stack is invoked. In embodiments of the invention, a text message may also be appended to the URL notification. The features, of the embodiments of the invention, may be provided as part of an Internet browser extension.

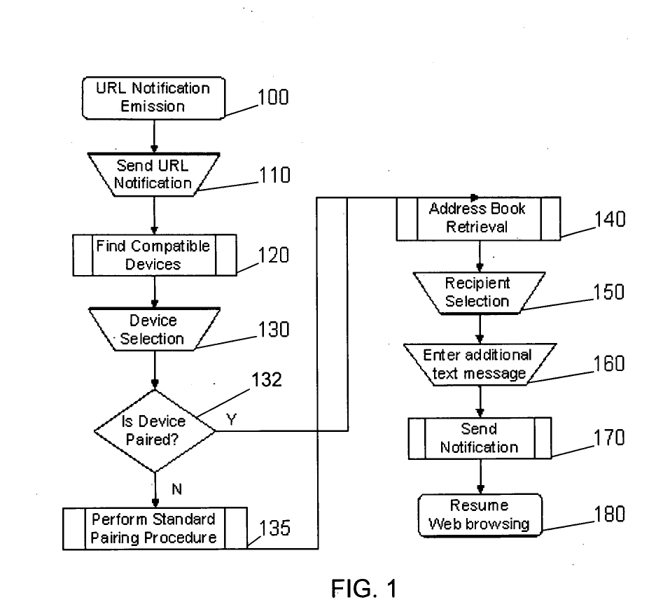

FIG. 1 illustrates a flow chart for sending a URL notification from a computing device to a recipient's mobile communication device. The process starts (block 100) with a user triggering a URL notification emission during an Internet session on a computer configured with embodiments of the invention. The user sends a URL notification (block 110) by pressing a “Send URL Notification” button in their web browser. The “Send URL Notification” button is provided by a browser extension in accordance with embodiments of the invention. Pressing the “Send URL Notification” button transmits the current URL to an Asynchronous URL Notification daemon. Compatible communication devices are found (block 120) with the Asynchronous URL Notification daemon interacting with a local Bluetooth stack to identify Bluetooth enabled devices in the vicinity of the computer that support the Asynchronous URL Notification profile, and a list may be displayed to the user in the form of a pop-up window. The user selects a device from the list (block 130), and this selection is sent back to the Asynchronous URL Notification daemon.

Continuing with FIG. 1, a determination is made (decision block 132) of whether the user's computing device is currently Bluetooth paired with the selected Bluetooth compatible device. In the event the user's computing device is not currently Bluetooth paired with the selected Bluetooth compatible device (decision block 132 is No), a standard pairing procedure offered by the local Bluetooth stack is invoked (block 135). In the event the user's computing device is already paired with the Bluetooth compatible device (decision block 132 is Yes), the Asynchronous URL Notification daemon retrieves the address book from the device selected in block 130 through a standard Phonebook Access Bluetooth profile (block 140). The list of recipients may be displayed to the user in the form of a pop-up window. The user selects the recipient to whom the URL Notification should be sent (block 150), and the selection is passed back to the Asynchronous URL Notification daemon. The Asynchronous URL Notification daemon allows the user to append an optional text message to the URL Notification, which is performed through yet another pop-up window (block 160). Subsequently, with the Asynchronous URL Notification Bluetooth profile, the Asynchronous URL Notification daemon tells the Bluetooth device selected in block 130 to compose a Control SMS containing the URL captured in block 110 and the optional text message entered in block 160, which is then sent to the recipient selected in block 150 (block 170). The sending process concludes after the selected device has sent the Control SMS, and the user's web browsing resumes (block 180).

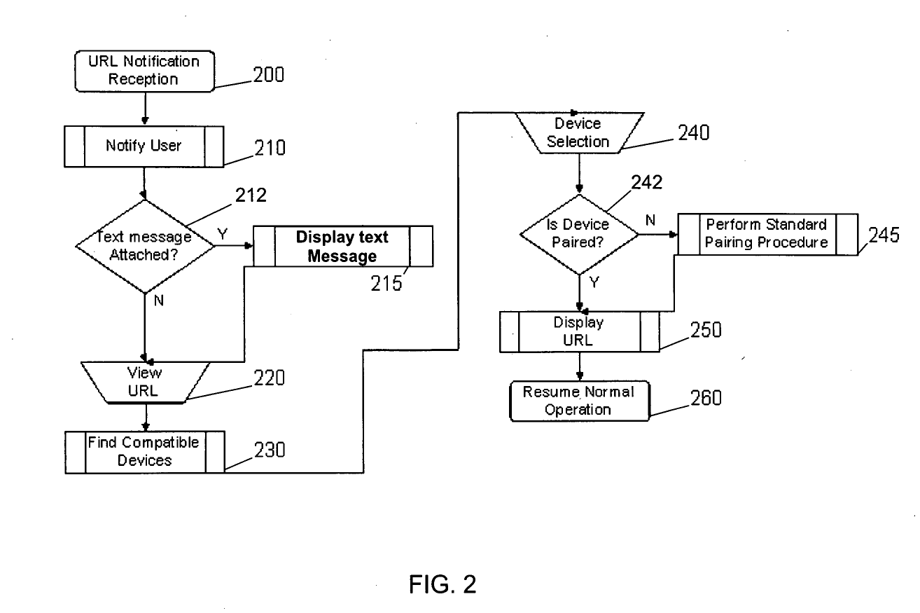

FIG. 2 illustrates a flow chart for receiving a URL notification at a mobile device, and displaying the received URL on a recipient's computing device according to embodiments of the invention. The process starts (block 200) when the triggering Control SMS from block 170 is received on a mobile device that supports Asynchronous URL Notification. A recipient user of the mobile device, which has been notified in block 200 is informed of the reception of an Asynchronous URL Notification event using typical device notification features, such as audio or visual alerts (block 210). A determination is made (decision block 212) of whether a text message is attached to the Control SMS, wherein in the event a text message has been attached (decision block 212 is Yes), the text message is displayed to the user on the receiving mobile device screen (block 215). Subsequently, the user pushes or selects a button associated with a View URL label on the keyboard of receiving mobile device (block 220).

Continuing with FIG. 2, the receiving mobile device utilizes its Bluetooth stack to identify Bluetooth computing equipment in the vicinity that support the Asynchronous URL Notification profile, and generates a list that is displayed to the recipient (block 230). Subsequently, the recipient selects a computing device from the list (block 240). A determination is made (decision block 242) of whether the recipient's mobile device is currently Bluetooth paired with the recipient's Bluetooth compatible computing device. In the event the recipient's selected computing device is not currently Bluetooth paired with the recipient's mobile device (decision block 242 is No), a standard pairing procedure offered by the local Bluetooth stack is invoked (block 245). Finally, using the Asynchronous URL Notification Bluetooth profile, the recipient's mobile device sends the URL to be displayed to the compatible computer selected in block 240, and the computer's Bluetooth stack opens a Web browser to the received URL through standard Multipurpose Internet Mail Extension (MIME) type associations.

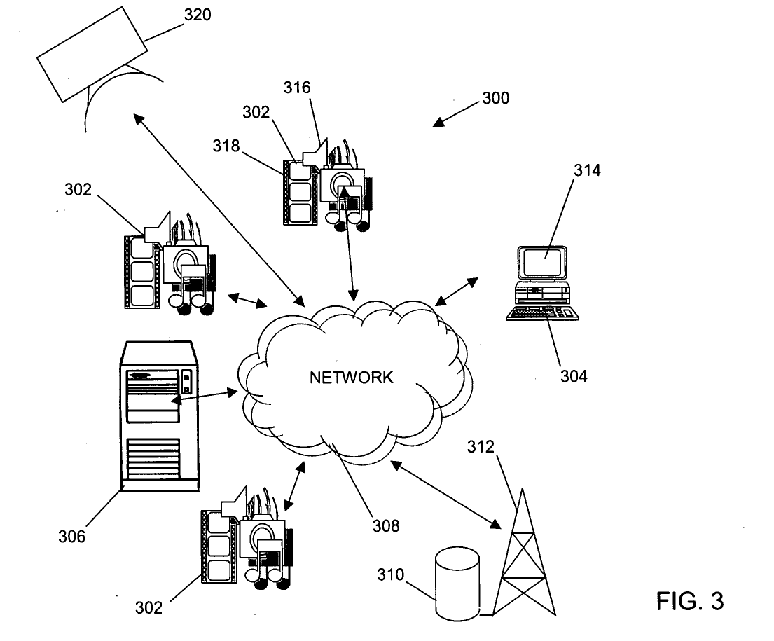

FIG. 3 is a block diagram of an exemplary system 300 configured for sending information, such as asynchronous URL notifications, to mobile device users who are not currently connected to the Internet. The system 300 includes multimedia devices 302, and desktop computer devices 304 configured with display capabilities 314. The multimedia devices 302 may be mobile communication and entertainment devices, such as cellular phones and mobile computing devices that are wirelessly connected to a network 308. The multimedia devices 302 have video displays 318 and audio outputs 316. The multimedia devices 302 and desktop computer devices 304 may be configured with software with a GUI for carrying out the information transfer functions of embodiments of the invention. The network 308 may be any type of known network including a fixed wire line network, cable and fiber optics, over the air broadcasts, satellite 320, local area network (LAN), wide area network (WAN), global network (e.g., Internet), intranet, etc. with data/Internet capabilities as represented by server 306. Communication aspects of the network are represented by cellular base station 310 and antenna 312. In a preferred embodiment, the network 308 is a LAN and each remote device 302 and desktop device 304 executes a user interface application (e.g., web browser) to contact the server system 306 through the network 308. Alternatively, the remote devices 302 and 304 may be implemented using a device programmed primarily for accessing network 308 such as a remote client.

The information transfer software, of embodiments of the invention, may be resident on the individual multimedia devices 302 and desktop computers 304, or stored within the server 306 or cellular base station 310.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

1. A method for sending a uniform resource locator (URL) notification from a computing device to a recipient's mobile communication device, wherein the method comprises:
generating a URL notification emission during an Internet session on a computing device in response to a user command;
sending the URL notification emission to an Asynchronous URL Notification daemon;
composing a Control SMS (short message service) that comprises the URL notification emission;
locating one or more compatible communication devices;
wherein the locating is performed with the Asynchronous URL Notification daemon interacting with a local Bluetooth stack to identify the one or more compatible communication devices;
wherein the one or more compatible communication devices are Bluetooth enabled devices in the vicinity of the computing device that support an Asynchronous URL Notification profile;
generating a list of one or more compatible communication devices;
receiving the user's selection of a compatible communication device from the list of one or more compatible communication devices;
pairing the selected compatible communication device with the computing device;
retrieving an address book from the selected compatible communication device;
displaying a list of recipients from the address book; and
sending the Control SMS to a recipient's mobile communication device in response to the user selection from the list of recipients.

2. The method of claim 1, wherein a text message is appended to the URL notification emission.

3. The method of claim 1, further comprising:
receiving the Control SMS at the recipient's mobile device;
notifying the recipient of the receiving of the Control SMS with the URL notification emission;
locating one or more recipient compatible computing devices;
wherein the locating is performed with the Asynchronous URL Notification daemon interacting with a local Bluetooth stack to identify the one or more recipient compatible computing devices;
wherein the one or more recipient compatible computing devices are Bluetooth enabled devices in the vicinity of the recipient's mobile device that support the Asynchronous URL Notification profile;
generating a list of one or more recipient compatible computing devices;
receiving the recipient's selection of a compatible computing device from the list of one or more recipient compatible computing devices;
pairing the selected recipient compatible computing device with the recipient's device;
sending the URL notification emission from the recipient's mobile device to the recipient's compatible computing device; and
opening a Web browser to the received URL notification emission through standard Multipurpose Internet Mail Extension (MIME) type associations on the recipient's compatible computing device.
